(19) United States
(12) Patent Application Publication
(10) Pub. No.: US 2018/0078441 A1
(43) Pub. Date: Mar. 22, 2018

(54) FOOT MASSAGE DEVICE

(71) Applicant: MARUTAKA CO., LTD, Tokyo (JP)

(72) Inventors: Satoshi KOBAYASHI, Tokyo (JP); Qiankun GU, Zhejiang (CN)

(73) Assignee: MARUTAKA CO., LTD, Tokyo (JP)

(21) Appl. No.: 15/554,905

(22) PCT Filed: Feb. 26, 2016
(86) PCT No.: PCT/JP2016/055880

§ 371 Date: Aug. 31, 2017

(30) Foreign Application Priority Data
Mar. 4, 2015 (JP) 2015-042884

(51) Int. Cl. A61H 1/00

(52) U.S. Cl. CPC A61H 1/005; A61H 1/008; A61H 2201/1238; A61H 2201/164; A61H 2201/1676; A61H 2201/0103

(57) ABSTRACT

A foot massage device capable of augmenting or restoring function of the transverse metatarsal ligament and alleviating foot pain felt by a user has increased massage effect on a user foot and is configured to be capable of imparting various stimuli to the user foot. A foot massage device includes: a cover body; a footrest including a footrest plate, a left/right rotary shaft, and a front/rear rotary shaft; an air bag including an inner instep air bag, a sole air bag, an outer instep air bag, and an ankle air bag; an air supply/exhaust device; a front/rear oscillation drive mechanism; and a base. The footrest plate oscillates left and right about the left/right rotary shaft in response to expansion and contraction of the air bag, and oscillates forward and backward about the front/rear rotary shaft in response to driving of the front/rear oscillation drive mechanism.

### TECHNICAL FIELD

The present invention relates to a foot massage device, and particularly relates to a foot massage device that massages a foot of a user by the user placing the foot on a footrest provided inside the foot massage device and shaking the footrest plate.

### BACKGROUND ART

A transverse metatarsal ligament may not sufficiently develop at the time of growth depending on the home environment or the living environment of a person, a function thereof deteriorates when legs are not regularly trained, and the function may be degraded due to an excessive load applied thereto depending on the footwear to be worn. Such a degradation of the function of the transverse metatarsal ligament causes foot fatigue or hallux valgus.

Here, for example, an ankle/toe exercise health device (for example, see Patent Document 1) that repeats motion of bending and extending a toe to a top side of a foot while bending an ankle of a user forward and backward by the user placing the foot on a footrest plate, fixing the toe to a movable plate using a belt, and operating a drive mechanism, a massager (for example, see Patent Document 2) which includes a footrest plate whose rear end side is rotatably supported and an air bag placed on a rear surface side of the footrest plate and in which the footrest plate vertically shakes using the rear end side as a fulcrum when the air bag expands and contracts, a toe massage machine (for example, see Patent Document 3) including a box-shaped footrest provided with a footrest plate pivotally supported such that forward tilting is allowed by shaking on an upper surface thereof and a protrusion at a front of the footrest, etc. have been conventionally proposed as a foot massage device that massages a foot of a user placed on a footrest plate provided inside the foot massage device by shaking the footrest plate.

In addition, for example, a sole massage machine (for example, see Patent Document 4) which includes an air bag facing an instep of a foot of a user accommodated in a foot accommodation portion accommodating the foot and a side air bag facing both sides of the foot, is provided with an air supply mechanism supplying air to the air bag, a foot massager (for example, see Patent Document 5) including an air bag that expands and contracts by intake and exhaust repeated on an inner surface of a foot accommodation portion, etc. have been conventionally proposed as a foot massage device that massages a foot of a user or fixes the foot inside the foot massage device by bringing the foot inserted into the foot massage device into contact with an expanding and contracting air bag.

### CITATION LIST

### Patent Document

Patent Document 1: JP 2002-143269 A

Patent Document 2: JP 09-313556 A

Patent Document 3: JP 2013-215417 A

Patent Document 4: JP 2007-136013 A

Patent Document 5: JP 57-7628 Y

### SUMMARY OF THE INVENTION

### Problem to be Solved by the Invention

However, the foot massage device that massages the foot of the user placed on the footrest plate by shaking the footrest plate provided inside the foot massage device according to the conventional technology described above corresponds to a device that contributes to improvement in health by bending and extending the toe to the instep side of the foot while bending the ankle back and forth to stimulate a place of an arch (for example, see Patent Document 1), a device that attempts to perform a stretch motion of the Achilles tendon of the foot, etc. (for example, see Patent Document 2), and a device that attempts chiropractic on the toe by acting on a root of the toe (for example, see Patent Document 3), and does not correspond to a device that attempts to enhance or recover the function of the transverse metatarsal ligament.

In this regard, a first problem of the invention is to provide a foot massage device capable of enhancing or recovering the function of the transverse metatarsal ligament with regard to the foot massage device that massages the foot of the user placed on the footrest plate by shaking the footrest plate provided inside the foot massage device.

In addition, there has been a problem that the user feels pain on the foot in many cases when the foot massage device performs massage such as bending and stretching from both side surfaces of the foot of the user with respect to the transverse metatarsal ligament.

Therefore, a second problem of the invention is to provide a foot massage device capable of relieving pain felt on the foot by the user with regard to the foot massage device capable of enhancing or recovering the function of the transverse metatarsal ligament by shaking the footrest plate provided inside the foot massage device to massage the foot of the user placed on the footrest plate.

In addition, since the foot massage device that massages the foot of the user placed on the footrest plate by shaking the footrest plate provided inside the foot massage device according to the conventional technology described above merely performs a single operation, there has been a problem that an effect of massage on the foot of the user is limited.

Therefore, a third problem of the invention is to provide a foot massage device that enhances the effect of massage on the foot of the user by being allowed to give various stimuli to the foot of the user with regard to the foot massage device capable of enhancing or recovering the function of the transverse metatarsal ligament by shaking the footrest plate provided inside the foot massage device to massage the foot of the user placed on the footrest plate.

### Means for Solving Problem

The invention has been proposed to solve each of the above problems, and has the following configuration. Hereinafter, numbers and symbols illustrated in drawings attached to the present application will be mentioned to assist understanding of the configuration of the invention.

A foot massage device (1) according to claim 1 includes a cover body (2), a footrest (3), an air bag (4), and an air supply/exhaust device (5). The cover body (2) is a box-shaped member and includes a foot accommodation portion (2a) for accommodating a foot (F) of a user and a foot insertion opening (2b) for inserting the foot (F) of the user. The footrest (3) includes a footrest plate (3a) and a left-right rotating shaft (3b). The footrest plate (3a) is a member for placing a sole of the user and is a plate-shaped member. The left-right rotating shaft (3b) is a shaft member for shaking the footrest plate (3a) from side to side, and the footrest plate (3a) is attached thereto. An air bag (41) for an inside of an instep is included as the air bag (4). The air bag (41) for the inside of the instep is a member for massaging the inside of the instep of the foot (F) of the user and pressing the inside of the instep of the foot (F) downward to shake the footrest plate (3a) from side to side, and is attached to a position of the foot accommodation portion (2a) facing the inside of the instep of the foot (F) of the user. The air supply/exhaust device (5) is a device for expanding the air bag (4) by supplying air to the air bag (4) and contracting the air bag (4) by exhausting air from the air bag (4), and is connected to the air bag (4) through an air supply/exhaust pipe.

The foot massage device (1) according to claim 2 is the foot massage device described in claim 1, in which the left-right rotating shaft (3b) is provided to incline with respect to the sole of the user placed on the footrest plate (3a).

The foot massage device (1) according to claim 3 is the foot massage device described in claim 1 or 2, in which an air bag (42) for a sole is further included as the air bag (4), and the air bag (42) for the sole is a member that expands to push up one end on either a right or left side of a lower surface of the footrest plate (3a), thereby shaking the footrest plate (3a) from side to side, and is disposed to face either a right or left side in a lower part of the footrest plate (3a) with the left-right rotating shaft (3b) interposed therebetween.

The foot massage device (1) according to claim 4 is the foot massage device described in any one of claims 1 to 3, in which an air bag (43) for an outside of the instep and/or an air bag (44) for an ankle is further included as the air bag (4), the air bag (43) for the outside of the instep is a member for massaging an outside of the instep of the foot (F) of the user, and is attached to a position of the foot accommodation portion (2a) facing the outside of the instep of the foot (F) of the user, and the air bag (44) for the ankle is a member for massaging the ankle of the user, and is attached to a position of the foot accommodation portion (2a) facing the ankle of the user.

The foot massage device (1) according to claim 5 is the foot massage device described in any one of claims 1 to 4, in which the footrest (3) includes a front-back rotating shaft (3c) and a front-back shake drive mechanism (6). The front-back rotating shaft (3c) is a shaft member for shaking the footrest plate (3a) back and forth and connects the footrest plate (3a) and the front-back shake drive mechanism (6) to each other. The front-back shake drive mechanism (6) is a drive mechanism for shaking the footrest plate (3a) back and forth by driving the front-back rotating shaft (3c).

### Effect of the Invention

The foot massage device according to the invention has the above configurations, and thus may obtain the following effects.

In the foot massage device (1) described in claim 1, first, the air supply/exhaust device (5) supplies air to the air bag (41) for the inside of the instep to expand the air bag (41), thereby massaging the inside of the instep of the foot (F) of the user and pressing the inside of the instep of the foot (F) downward. Then, the footrest plate (3a) rotates using the left-right rotating shaft (3b) as a center axis, and inclines toward the inside of the instep.

In the foot massage device (1) described in claim 1, subsequently, the air supply/exhaust device (5) exhausts air from the air bag (41) for the inside of the instep to contract the air bag (41). Then, the footrest plate (3a) rotates using the left-right rotating shaft (3b) as a center axis to return to an original position.

Therefore, the foot massage device (1) described in claim 1 shakes the footrest plate (3a) from side to side by repeating the above-described operation, thereby enabling the footrest (3) to stimulate a transverse metatarsal ligament of the foot (F) of the user.

Then, the foot massage device (1) described in claim 1 may solve the first problem of the invention of providing a foot massage device capable of enhancing or recovering a function of the transverse metatarsal ligament with regard to a foot massage device that massages the foot (F) of the user placed on the footrest plate by shaking the footrest plate provided inside the foot massage device.

In addition, since the foot massage device (1) described in claim 1 performs bending and stretching from one side surface of the foot of the user with respect to the transverse metatarsal ligament as described above, pain felt on the foot by the user is relieved.

Therefore, the foot massage device (1) described in claim 1 may solve the second problem of the invention of providing a foot massage device capable of relieving pain felt on the foot by the user with regard to the foot massage device capable of enhancing or recovering the function of the transverse metatarsal ligament by shaking the footrest plate provided inside the foot massage device to massage the foot of the user placed on the footrest plate.

Next, first, the foot massage device (1) described in claim 2 pushes one end on either a right or left side of the footrest plate (3a) upward when the air supply/exhaust device (5) expands the air bag (42) for the sole by supplying air to the air bag (42). Then, the footrest plate (3a) rotates using the left-right rotating shaft (3b) as a center axis, and inclines toward the inside of the instep of the foot (F) of the user.

In the foot massage device (1) according to claim 2, as described above, the left-right rotating shaft (3b) is provided to incline with respect to the sole of the user placed on the footrest plate (3a). Therefore, when the footrest plate (3a) shakes from side to side, the sole of the user moves to twist, and thus the footrest (3) may more suitably stimulate the transverse metatarsal ligament of the foot of the user. Then, the foot massage device (1) described in claim 2 is more suitable to solve the first problem and the second problem of the invention described above.

In addition, in the foot massage device (1) described in claim 3, the air supply/exhaust device (5) contracts the air bag (42) for the sole by exhausting air from the air bag (42). Then, the footrest plate (3a) rotates using the left-right rotating shaft (3b) as a center axis, and returns to the original position.

The foot of the user has various sizes or weights. Therefore, according to the foot massage device (1) described in claim 3, when the air bag (42) for the sole is included, the footrest plate (3a) may be shaken from side to side to enable the footrest (3) to reliably stimulate the transverse metatarsal ligament of the foot of the user. Thus, the foot massage device (1) described in claim 3 is more suitable to solve the first problem and the second problem of the invention described above.

Further, in the foot massage device (1) described in claim 4, the air bag (43) for the outside of the instep expands by being supplied with air by the air supply/exhaust device (5) and contracts by the air supply/exhaust device (5) exhausting air therefrom, thereby massaging the outside of the instep of the foot (F) of the user. In addition, the air bag (44) for the ankle expands by being supplied with air by the air supply/exhaust device (5) and contracts by the air supply/exhaust device (5) exhausting air therefrom, thereby massaging the ankle of the user.

Furthermore, in the foot massage device (1) according to claim 5, the footrest plate (3a) shakes back and forth to exercise the ankle of the user when the front-back shake drive mechanism (6) drives the front-back rotating shaft (3c).

Therefore, the foot massage device (1) according to claims 4 and 5 may solve the third problem of the invention of providing a foot massage device that enhances the effect of massage on the foot of the user by being allowed to give various stimuli to the foot of the user with regard to the foot massage device capable of enhancing or recovering the function of the transverse metatarsal ligament by shaking the footrest plate provided inside the foot massage device to massage the foot of the user placed on the footrest plate.

### BRIEF DESCRIPTION OF DRAWINGS

FIG. 1 is a plan view illustrating a foot massage device according to an embodiment of the invention;

FIG. 2 is a partial cross-sectional view illustrating the foot massage device according to the embodiment of the invention;

FIG. 3 is a partial cross-sectional view illustrating the foot massage device according to the embodiment of the invention;

FIG. 4 is a perspective view illustrating a footrest plate in the foot massage device according to the embodiment of the invention;

FIG. 5 is a perspective view illustrating a footrest plate in the foot massage device according to the embodiment of the invention;

FIG. 6 is a cross-sectional view illustrating the foot massage device according to the embodiment of the invention;

FIG. 7 is a cross-sectional view illustrating the foot massage device according to the embodiment of the invention;

FIG. 8 is a perspective view illustrating a footrest plate in the foot massage device according to the embodiment of the invention;

FIG. 9 is a cross-sectional view illustrating the foot massage device according to the embodiment of the invention;

FIG. 10 is a cross-sectional view illustrating the foot massage device according to the embodiment of the invention;

FIG. 11 is a perspective view illustrating a footrest plate in the foot massage device according to the embodiment of the invention;

FIG. 12 is a cross-sectional view illustrating the foot massage device according to the embodiment of the invention;

FIG. 13 is a cross-sectional view illustrating the foot massage device according to the embodiment of the invention;

FIG. 14 is a perspective view illustrating a footrest plate in the foot massage device according to the embodiment of the invention;

FIG. 15 is a cross-sectional view illustrating the foot massage device according to the embodiment of the invention;

FIG. 16 is a cross-sectional view illustrating the foot massage device according to the embodiment of the invention;

FIG. 17 is a cross-sectional view illustrating the foot massage device according to the embodiment of the invention;

FIG. 18 is a cross-sectional view illustrating the foot massage device according to the embodiment of the invention; and

FIG. 19 is a partial cross-sectional view illustrating the foot massage device according to the embodiment of the invention.

### MODE(S) FOR CARRYING OUT THE INVENTION

Hereinafter, a description will be given of a structure and a usage mode of a foot massage device according to an embodiment of the invention based on accompanying drawings.

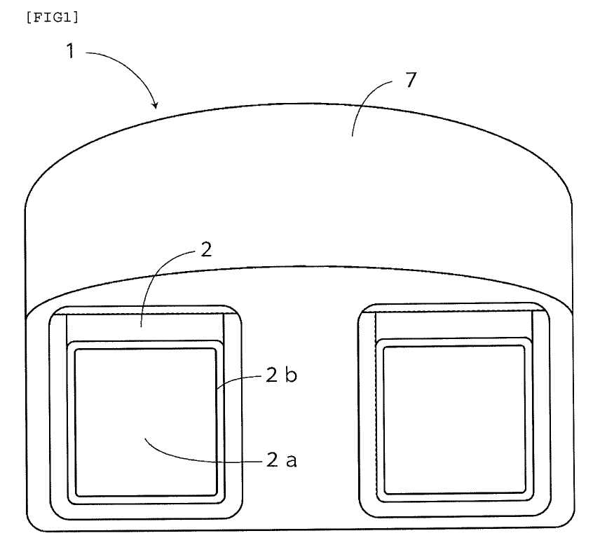

As illustrated in the figure, a foot massage device (1) according to the invention includes a cover body (2), a footrest (3), an air bag (4), an air supply/exhaust device (5), a front-back shake drive mechanism (6), and a base (7). When the foot massage device (1) is intended to massage both legs of a person, one foot massage device (1) may be provided for one foot as illustrated in FIG. 1. In addition, when the foot massage device (1) is intended to massage one leg of the person, only one foot massage device (1) may be provided.

As illustrated in the figure, the base (7) is a box-shaped member for housing various members included in the foot massage device (1). The base (7) is formed using metal, wood, plastic, etc., and a material thereof is not particularly limited as long as the material is a strong material that can withstand a weight of a foot (F) of a user.

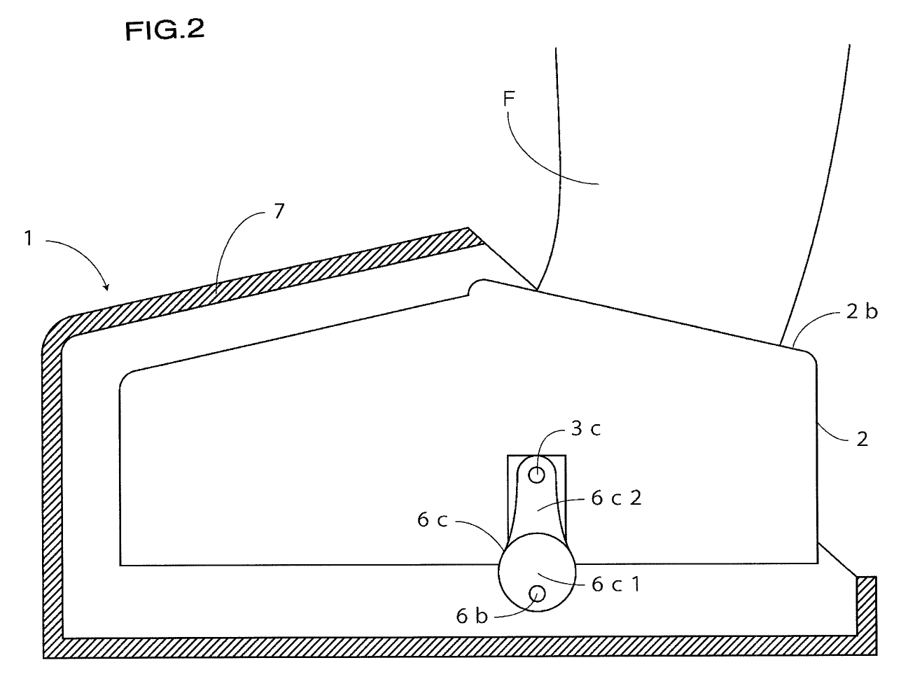

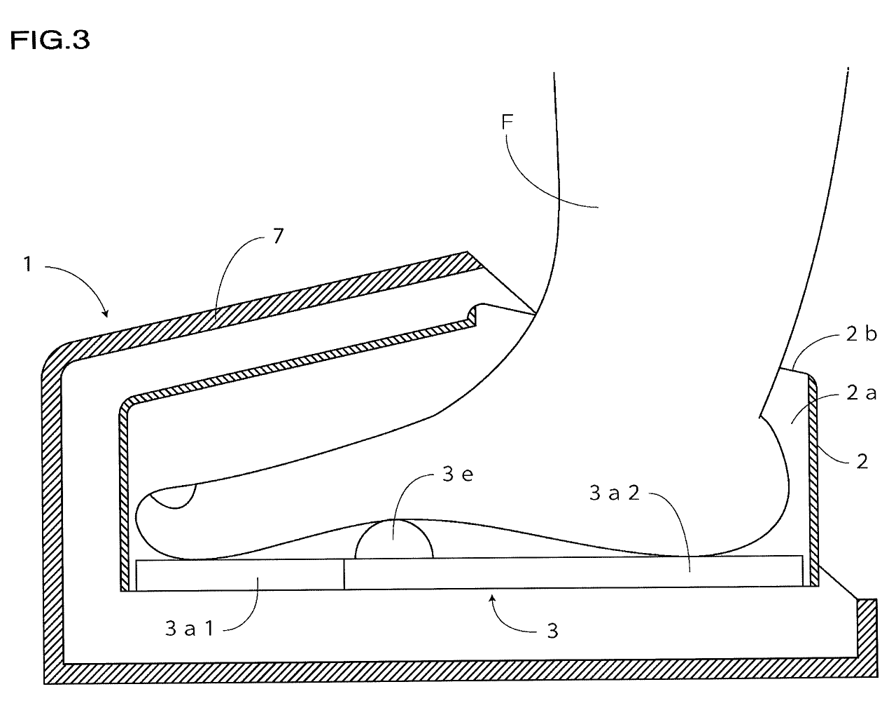

As illustrated in FIG. 2 and FIG. 3, the cover body (2) is a box-shaped member, and includes a foot accommodation portion (2a) for accommodating the foot of the user and a foot insertion opening (2b) for inserting the foot of the user into the foot accommodation portion (2a). When the cover body (2) is formed in a shoe shape as illustrated in the figure, the cover body (2) is suitably adapted to a shape of the foot of the user. As illustrated in the figure, the foot accommodation portion (2a) has a size that allows accommodation of at least a part from a toe to an ankle of the foot (F) of the user, and the foot insertion opening (2b) has a size that allows the foot (F) of the user to be guided into the foot accommodation portion (2a).

As illustrated in the figure, the footrest (3) includes a footrest plate (3a), a left-right rotating shaft (3b), and a front-back rotating shaft (3c).

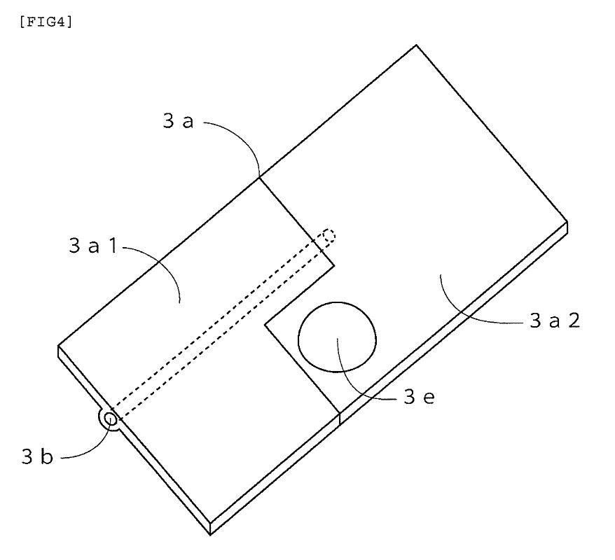

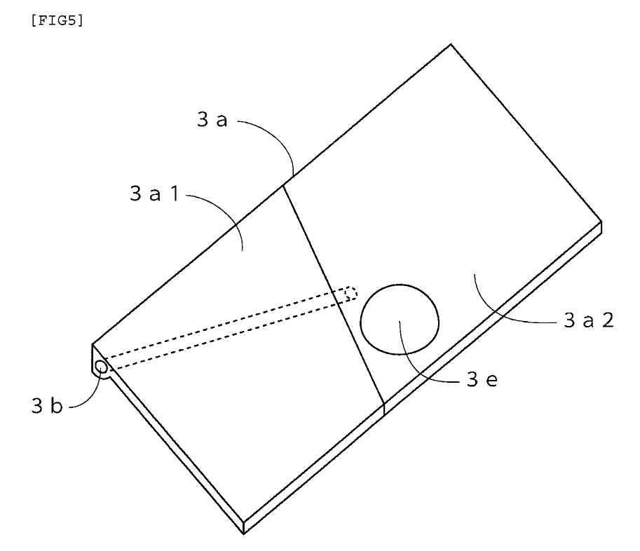

The footrest plate (3a) is a member on which a sole of the user is placed and is a plate-shaped member. For example, the footrest plate (3a) may be formed by connecting a first footrest plate (3a1) and a second footrest plate (3a2) corresponding to plate-shaped members having L shapes in a planar view such that the footrest plates fit together as illustrated in FIG. 4, or may be formed by connecting a first footrest plate (3a1) and a second footrest plate (3a2) having slopes at sides facing each other such that the footrest plates fit together as illustrated in FIG. 5. In the figure, the footrest plate (3a) has a rectangular shape as an overall shape in a planar view. However, the shape is not particularly limited when the user may place the sole thereon. In addition, as illustrated in the figure, one or a plurality of protrusions (3e) may be provided on an upper surface of the footrest plate (3a) to stimulate the sole of the user.

The left-right rotating shaft (3b) is a shaft member for shaking the footrest plate (3a) from side to side, and the footrest plate (3a) is attached thereto. In FIG. 4, the left-right rotating shaft (3b) is provided in parallel with a longer direction of the footrest plate (3a). However, as illustrated in FIG. 5, the left-right rotating shaft (3b) may be provided to incline with respect to the sole of the user placed on the footrest plate (3a). When the left-right rotating shaft (3b) is provided to incline with respect to the sole of the user placed on the footrest plate (3a), and the footrest plate (3a) shakes from side to side, the sole of the user moves to twist, and thus the footrest (3) may more suitably stimulate a transverse metatarsal ligament of the foot of the user.

The front-back rotating shaft (3c) is a shaft member for shaking the footrest plate (3a) back and forth, and connects the footrest plate (3a) and the front-back shake drive mechanism (6) to each other.

As illustrated in the figure, the air bag (4) includes an air bag (41) for an inside of the instep, an air bag (42) for the sole, an air bag (43) for an outside of the instep, and an air bag (44) for the ankle. It suffices to install the air bag (42) for the sole, the air bag (43) for the outside of the instep, and the air bag (44) for the ankle as necessary. A known bag-shaped air bag made of a flexible material such as cloth which may repeatedly perform expansion by air supply and contraction by air exhaust may be used as the air bag (4), and a bellows-type air bag, etc. may be used as necessary.

The air supply/exhaust device (5) is a device for expanding the air bag (4) by supplying air and contracting the air bag (4) by exhausting air from the air bag (4), and is connected to the air bag (4) through an air supply/exhaust pipe. A known air supply/exhaust device such as an electric type air pump, an electric type air compressor, etc. may be used as the air supply/exhaust device (5).

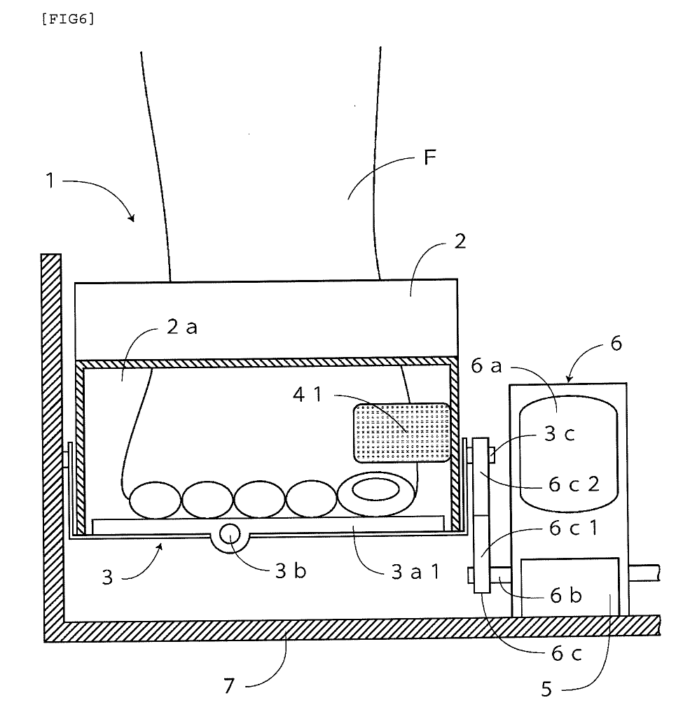

The air bag (41) for the inside of the instep is a member for massaging the inside of the instep of the foot (F) of the user and shaking the footrest plate (3a) from side to side by pressing the inside of the instep of the foot (F) downward, and is installed at a position facing the inside of the instep of the foot (F) of the user in the foot accommodation portion (2a) as illustrated in FIG. 6.

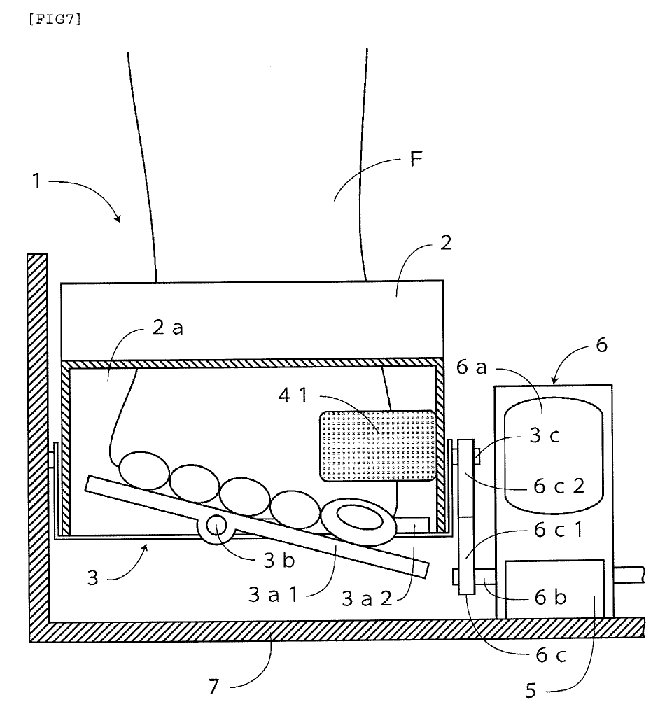

Then, first, as illustrated in FIG. 7, the air supply/exhaust device (5) supplies air to the air bag (41) for the inside of the instep to expand the air bag (41), thereby massaging the inside of the instep of the foot (F) of the user and pressing the inside of the instep of the foot (F) downward. Then, the footrest plate (3a) rotates using the left-right rotating shaft (3b) as a center axis, and inclines toward the inside of the instep of the foot (F) of the user.

Subsequently, the air supply/exhaust device (5) exhausts air from the air bag (41) for the inside of the instep to contract the air bag (41). Then, as illustrated in FIG. 6, the footrest plate (3a) rotates using the left-right rotating shaft (3b) as a center axis to return to an original position.

The foot massage device (1) shakes the footrest plate (3a) from side to side by repeating the above-described operation, thereby enabling the footrest (3) to stimulate the transverse metatarsal ligament of the foot of the user.

The air bag (42) for the sole may be further included as the air bag (4). The air bag (42) for the sole is a member that expands to push up one end on either a right or left side of a lower surface of the footrest plate (3a), thereby shaking the footrest plate (3a) from side to side, and is disposed to face either a right or left side in a lower part of the footrest plate (3a) with the left-right rotating shaft (3b) interposed therebetween.

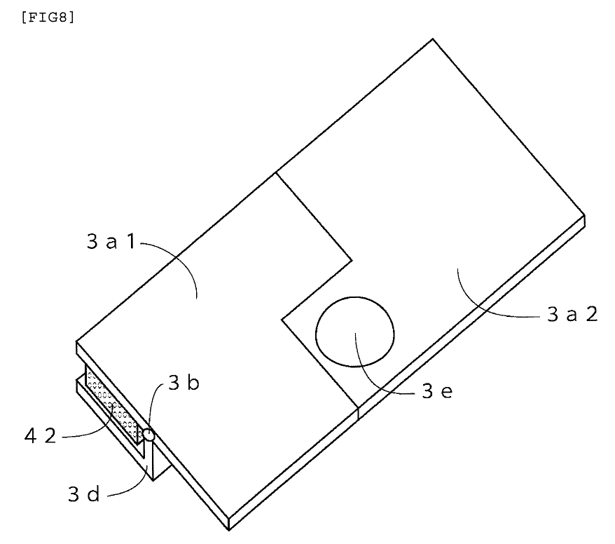

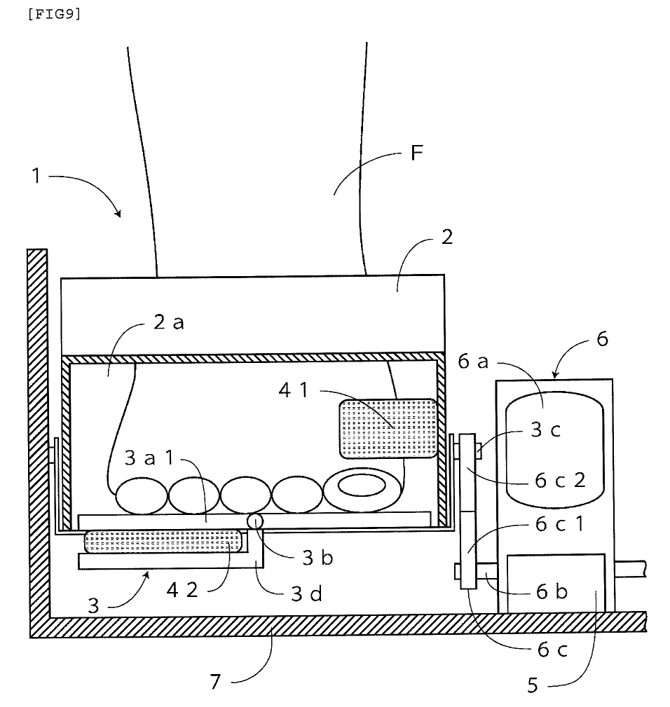

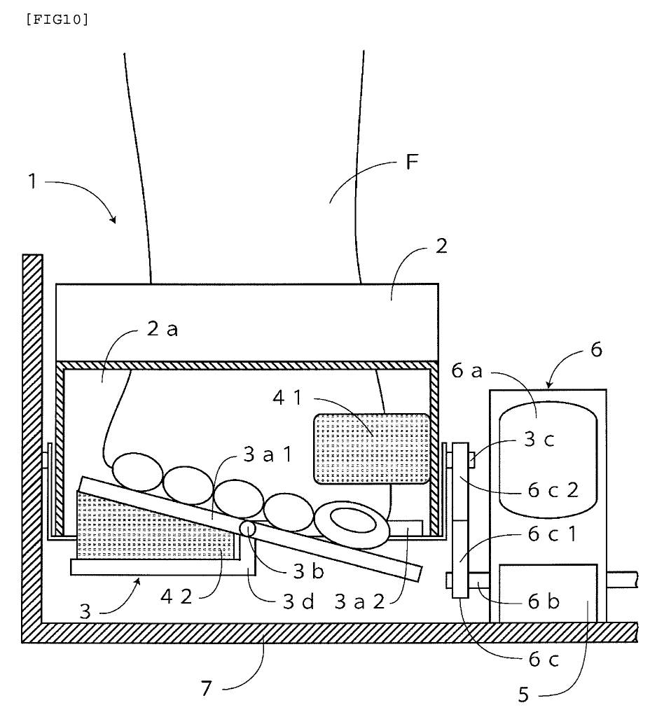

Here, various arrangements may be considered for an arrangement of the air bag (42) for the sole. First, as illustrated in FIG. 8 to FIG. 10, a plate-shaped air bag placing plate (3d) provided with a side wall at the left-right rotating shaft (3b) side may be connected to an outer side of the foot of the user in a lower part of the plate-shaped first footrest plate (3a1) having the L shape in the planar view through the left-right rotating shaft (3b), and the air bag (42) for the sole may be interposed in a gap between a lower surface of the first footrest plate (3a1) and an upper surface of the air bag placing plate (3d) and installed on the air bag placing plate (3d).

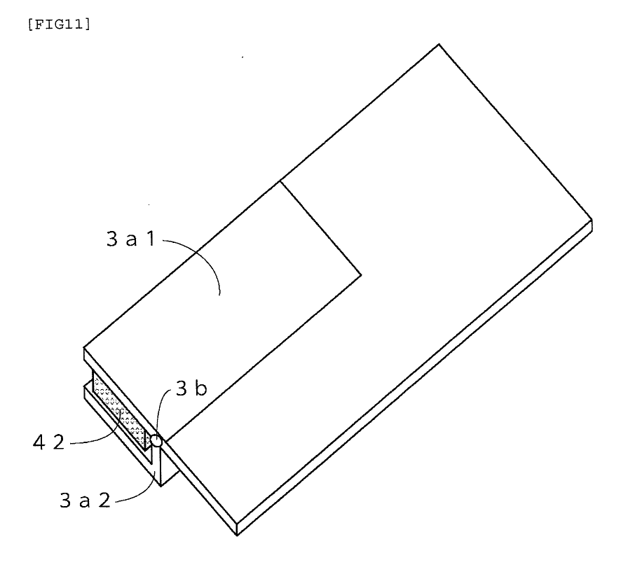

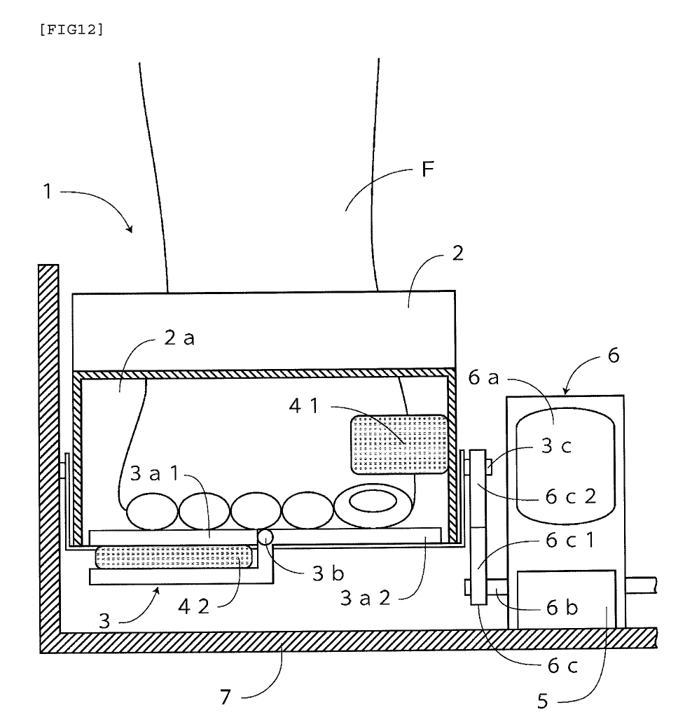

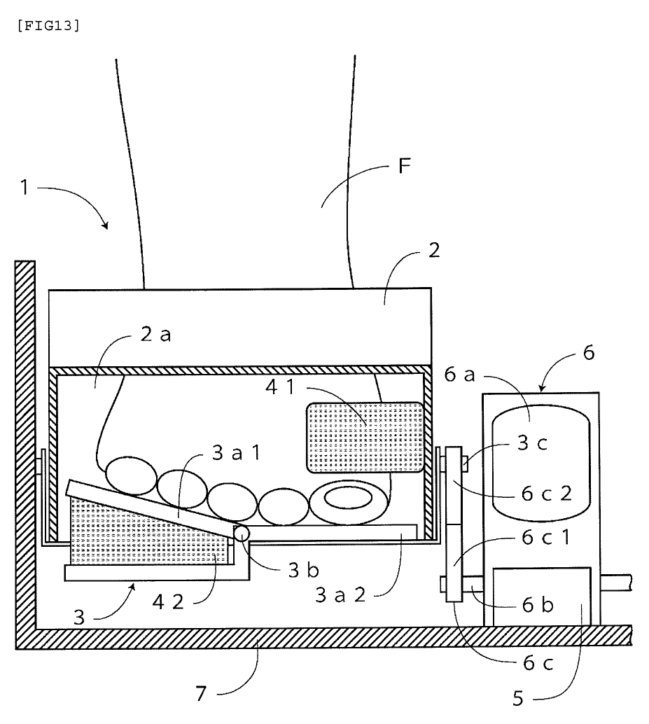

In addition, as illustrated in FIG. 11 to FIG. 13, the plate-shaped first footrest plate (3a1) having a rectangular shape in a planar view and the second footrest plate (3a2) provided with a depression at a position facing the first footrest plate (3a1) are connected through the left-right rotating shaft (3b), and the air bag (42) for the sole may be interposed in a gap between the lower surface of the first footrest plate (3a1) and an upper surface of the second footrest plate (3a2) and installed on the second footrest plate (3a2).

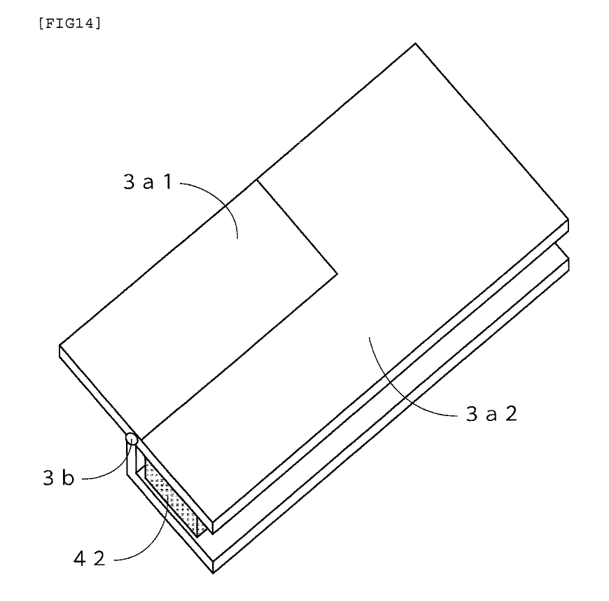

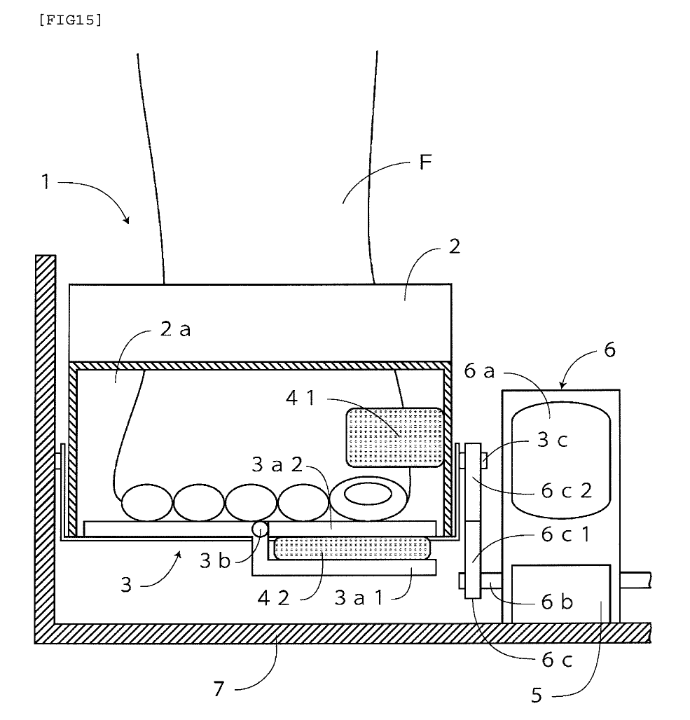

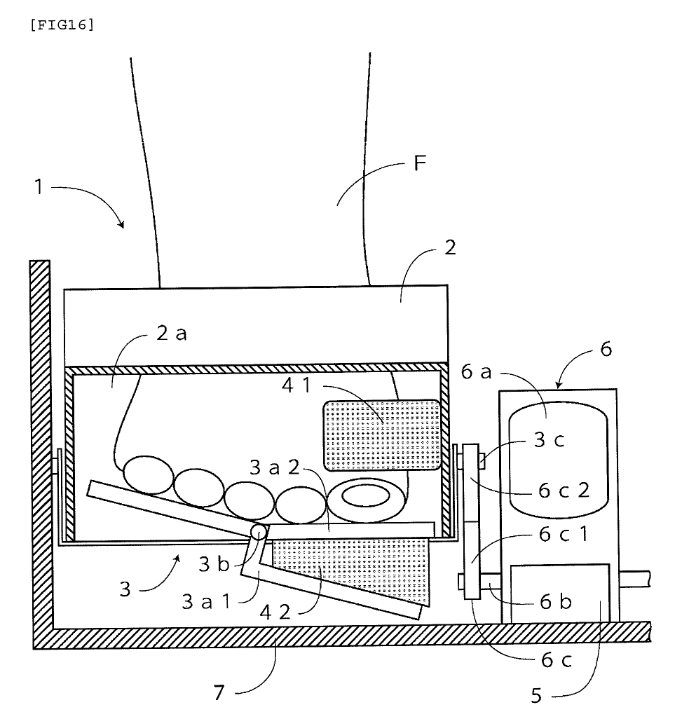

Alternatively, as illustrated in FIG. 14 to FIG. 16, the first footrest plate (3a1) provided with a depression on an inner side of the foot of the user and the plate-shaped second footrest plate (3a2) having the L shape in the planar view may be connected through the left-right rotating shaft (3b), and the air bag (42) for the sole may be interposed in a gap between an upper surface of the first footrest plate (3a1) and a lower surface of the second footrest plate (3a2) and installed on the first footrest plate (3a1). In this case, an area in which the air bag (42) for the sole is installed may be relatively wide, and thus a relatively large air bag (42) for the sole may be used, which is suitable.

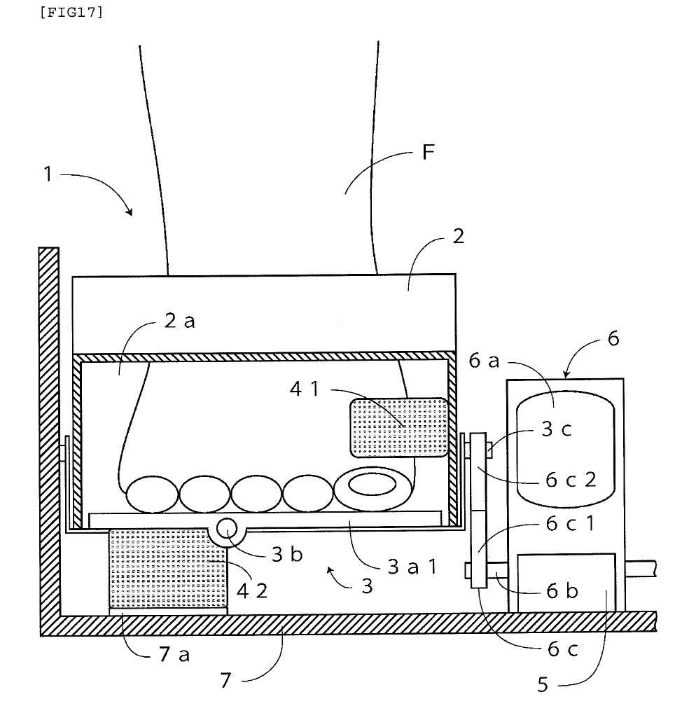

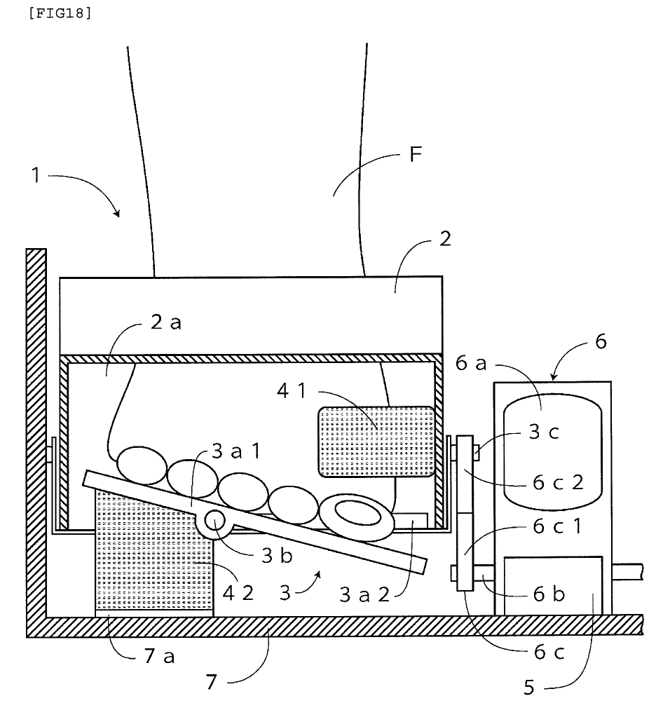

In addition, as illustrated in FIG. 17 and FIG. 18, the air bag (42) for the sole may be attached to a position of the base (7) facing a front portion of the footrest (3). In this case, when the air bag (42) for the sole is attached to the base (7) through an inclined table (7a), the footrest plate (3a) may be shaken from side to side at the time of inclining the footrest plate (3a) forward by the front-back shake drive mechanism (6).

First, the above-described air bag (42) for the sole expands by being supplied with air by the air supply/exhaust device (5), and pushes up one end on either the right or left side of the footrest plate (3a). Then, the footrest plate (3a) rotates using the left-right rotating shaft (3b) as a center axis, and inclines toward the inside of the instep.

Subsequently, the air bag (42) for the sole contracts by the air supply/exhaust device (5) exhausting air therefrom. Then, the footrest plate (3a) rotates using the left-right rotating shaft (3b) as a center axis, and returns to the original position.

Since the foot of the user has various sizes or weights, when the air bag (42) for the sole is included in addition to the air bag (41) for the inside of the instep as described above, the footrest plate (3a) may be shaken from side to side to enable the footrest (3) to reliably stimulate the transverse metatarsal ligament of the foot of the user, which is more suitable.

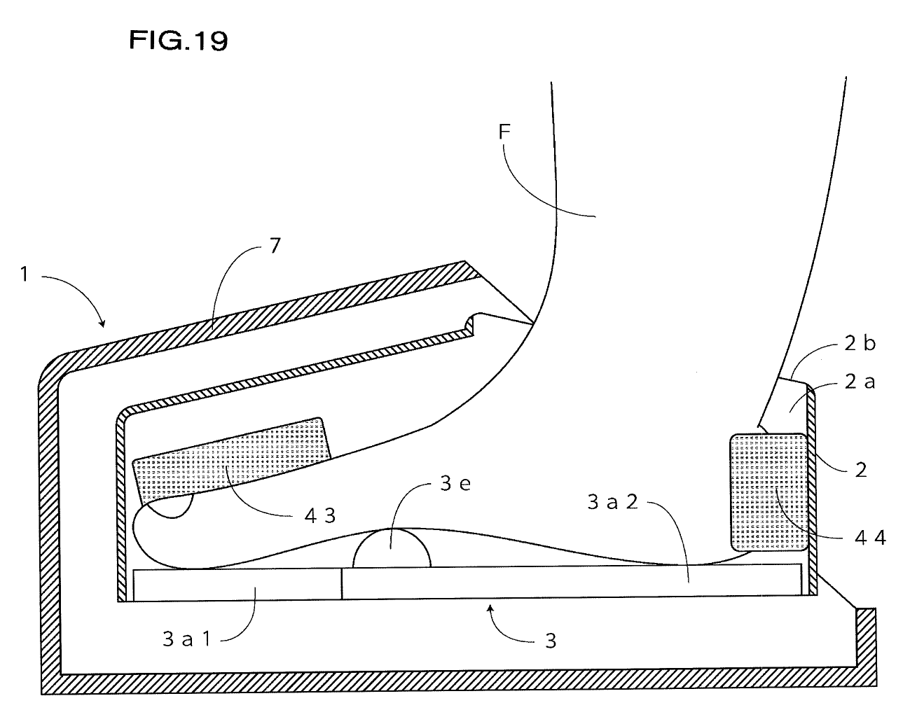

As illustrated in FIG. 19, the air bag (43) for the outside of the instep is attached to a position of the foot accommodation portion (2a) facing an outside of the instep of the foot of the user. Further, the air bag (43) expands by being supplied with air by the air supply/exhaust device (5) connected by the air supply/exhaust pipe and contracts by the air supply/exhaust device (5) exhausting air therefrom, thereby massaging the outside of the instep of the foot of the user.

As illustrated in FIG. 19, the air bag (44) for the ankle is attached to a position of the foot accommodation portion (2a) facing the ankle of the user. Further, the air bag (44) expands by being supplied with air by the air supply/exhaust device (5) connected by the air supply/exhaust pipe and contracts by the air supply/exhaust device (5) exhausting air therefrom, thereby massaging the ankle of the user.

As illustrated in the figure, the front-back shake drive mechanism (6) is a drive mechanism for shaking the footrest plate (3a) back and forth by driving the front-back rotating shaft (3c). The front-back shake drive mechanism (6) includes a driving body (6a), a rotating shaft (6b), and a rotating plate (6c). A known driving body such as an electric motor may be used as the driving body (6a). The rotating shaft (6b) is a shaft member that connects the driving body (6a) and the rotating plate (6c) to each other, and is a member for transmitting a driving force generated by the driving body (6a) to the rotating plate (6c). The rotating plate (6c) is a plate-shaped member, and includes a circular portion (6c1) and a bulging portion (6c2) raised on a circumferential surface thereof. The rotating shaft (6b) is attached to the circular portion (6c1), and one end of the front-back rotating shaft (3c) is attached to a distal end portion of the bulging portion (6c2).

When the driving body (6a) is driven, a driving force thereof is transmitted to the rotating plate (6c) through the rotating shaft (6b) to rotate the rotating plate (6c). Then, since the one end of the front-back rotating shaft (3c) is attached to the distal end portion of the bulging portion (6c2), the footrest plate (3a) may shake back and forth to exercise the ankle of the user.

### EXPLANATIONS OF LETTERS OR NUMERALS

1 foot massage device

2 cover body

2a foot accommodation portion

2b foot insertion opening

3 footrest

3a footrest plate

3a1 first footrest plate

3a2 second footrest plate

3b left-right rotating shaft

3c front-back rotating shaft

3d air bag placing plate

3e protrusion

4 air bag

41 air bag for inside of instep

42 air bag for sole

43 air bag for outside of instep

44 air bag for ankle

5 air supply/exhaust device

6 front-back shake drive mechanism

6a driving body

6b rotating shaft

6c rotating plate

6c1 circular portion

6c2 bulging portion

7 base

7a inclined table

F foot

1. A foot massage device comprising:
a cover body;
a footrest;
an air bag; and
an air supplier/exhauster,
wherein the cover body is box-shaped and includes a foot accommodation portion for accommodating a foot of a user and a foot insertion opening for inserting the foot of the user,
the footrest includes a footrest plate and a left-right rotating shaft,
the footrest plate is configured to place a sole of the user and is plate-shaped,
the left-right rotating shaft is configured to shake the footrest plate from side to side, and the footrest plate is attached thereto,
an air bag for an inside of an instep is included as the air bag,
the air bag for the inside of the instep is configured to massage the inside of the instep of the foot of the user and press the inside of the instep of the foot downward to shake the footrest plate from side to side, and is attached to a position of the foot accommodation portion facing the inside of the instep of the foot of the user, and
the air supplier/exhauster is configured to expand the air bag by supplying air to the air bag and contract the air bag by exhausting air from the air bag, and is connected to the air bag through an air supply/exhaust pipe.

2. The foot massage device according to claim 1, wherein the left-right rotating shaft is provided to incline with respect to the sole of the user placed on the footrest plate.

3. The foot massage device according to claim 1, wherein an air bag for a sole is further included as the air bag, and the air bag for the sole is configured to expand to push up one end on either a right or left side of a lower surface of the footrest plate, thereby shaking the footrest plate from side to side, and is disposed to face either a right or left side in a lower part of the footrest plate with the left-right rotating shaft interposed therebetween.

4. The foot massage device according to claim 1, wherein an air bag for an outside of the instep and/or an air bag for an ankle is further included as the air bag, the air bag for the outside of the instep is configured to massage an outside of the instep of the foot of the user, and is attached to a position of the foot accommodation portion facing the outside of the instep of the foot of the user, and the air bag for the ankle is configured to massage the ankle of the user, and is attached to a position of the foot accommodation portion facing the ankle of the user.

5. The foot massage device according to claim 1, wherein the footrest includes a front-back rotating shaft and a front-back shake driver, the front-back rotating shaft is configured to shake the footrest plate back and forth and connects the footrest plate and the front-back driver to each other, and the front-back shake driver is configured to shake the footrest plate back and forth by driving the front-back rotating shaft.

6. The foot massage device according to claim 2, wherein an air bag for a sole is further included as the air bag, and the air bag for the sole is configured to expand to push up one end on either a right or left side of a lower surface of the footrest plate, thereby shaking the footrest plate from side to side, and is disposed to face either a right or left side in a lower part of the footrest plate with the left-right rotating shaft interposed therebetween.

7. The foot massage device according to claim 2, wherein an air bag for an outside of the instep and/or an air bag for an ankle is further included as the air bag, the air bag for the outside of the instep is configured to massage an outside of the instep of the foot of the user, and is attached to a position of the foot accommodation portion facing the outside of the instep of the foot of the user, and the air bag for the ankle is configured to massage the ankle of the user, and is attached to a position of the foot accommodation portion facing the ankle of the user.

8. The foot massage device according to claim 3, wherein an air bag for an outside of the instep and/or an air bag for an ankle is further included as the air bag, the air bag for the outside of the instep is configured to massage an outside of the instep of the foot of the user, and is attached to a position of the foot accommodation portion facing the outside of the instep of the foot of the user, and the air bag for the ankle is configured to massage the ankle of the user, and is attached to a position of the foot accommodation portion facing the ankle of the user.

9. The foot massage device according to claim 6, wherein an air bag for an outside of the instep and/or an air bag for an ankle is further included as the air bag, the air bag for the outside of the instep is configured to massage an outside of the instep of the foot of the user, and is attached to a position of the foot accommodation portion facing the outside of the instep of the foot of the user, and the air bag for the ankle is configured to massage the ankle of the user, and is attached to a position of the foot accommodation portion facing the ankle of the user.

10. The foot massage device according to claim 2, wherein the footrest includes a front-back rotating shaft and a front-back shake driver, the front-back rotating shaft is configured to shake the footrest plate back and forth and connects the footrest plate and the front-back shake driver to each other, and the front-back shake driver is configured to shake the footrest plate back and forth by driving the front-back rotating shaft.

11. The foot massage device according to claim 3, wherein the footrest includes a front-back rotating shaft and a front-back shake driver, the front-back rotating shaft is configured to shake the footrest plate back and forth and connects the footrest plate and the front-back shake driver to each other, and the front-back shake driver is configured to shake the footrest plate back and forth by driving the front-back rotating shaft.

12. The foot massage device according to claim 4, wherein the footrest includes a front-back rotating shaft and a front-back shake driver, the front-back rotating shaft is configured to shake the footrest plate back and forth and connects the footrest plate and the front-back shake driver to each other, and the front-back shake driver is configured to shake the footrest plate back and forth by driving the front-back rotating shaft.

13. The foot massage device according to claim 6, wherein the footrest includes a front-back rotating shaft and a front-back shake driver, the front-back rotating shaft is configured to shake the footrest plate back and forth and connects the footrest plate and the front-back shake driver to each other, and the front-back shake driver is configured to shake the footrest plate back and forth by driving the front-back rotating shaft.

14. The foot massage device according to claim 7, wherein the footrest includes a front-back rotating shaft and a front-back shake driver, the front-back rotating shaft is configured to shake the footrest plate back and forth and connects the footrest plate and the front-back shake driver to each other, and the front-back shake driver is configured to shake the footrest plate back and forth by driving the front-back rotating shaft.

15. The foot massage device according to claim 8, wherein the footrest includes a front-back rotating shaft and a front-back shake driver, the front-back rotating shaft is configured to shake the footrest plate back and forth and connects the footrest plate and the front-back shake driver to each other, and the front-back shake is configured to shake the footrest plate back and forth by driving the front-back rotating shaft.

16. The foot massage device according to claim 9, wherein the footrest includes a front-back rotating shaft and a front-back shake driver, the front-back rotating shaft is configured to shake the footrest plate back and forth and connects the footrest plate and the front-back shake driver to each other, and the front-back shake driver is configured to shake the footrest plate back and forth by driving the front-back rotating shaft.
